(19) United States
(12) Patent Application Publication
(10) Pub. No.: US 2006/0108177 A1
(43) Pub. Date: May 25, 2006

(54) Rescue arrangement

(75) Inventor: Nicolas Paul Monks, Tilburg (NL)

Correspondence Address: BROWDY AND NEIMARK, P.L.L.C.;624 NINTH STREET, NW, SUITE 300, WASHINGTON, DC, 20001-5303, US

(73) Assignee: Baron Caotes B.V., Tilburg (NL)

(21) Appl. No.: 10/527,825

(22) PCT Filed: Sep. 9, 2003
(86) PCT No.: PCT/EP03/10260

§ 371 Date: Oct. 24, 2005

(30) Foreign Application Priority Data
Sep. 13, 2002 (EP) 02078826.1

(51) Int. Cl. A62B 1/00

(52) U.S. Cl. 182/82

(57) ABSTRACT

A rescue arrangement for effecting a rapid descent from a higher level to a lower level. The rescue arrangement comprises guiding means which substantially extend between the higher level and the lower level. Further it comprises carrying means which are connectable with the guiding means for carrying an object, in particular a person, from the higher level to the lower level via the guiding means. It also comprises first braking means located at the guiding means near the lower level for slowing down and/or stopping the carrying means near the lower level. The guiding means comprise at least two substantially parallel tracks, wherein the carrying means are adapted to be connected to at least two of the tracks.

The present invention relates to a rescue arrangement for effecting a rapid descent from a higher level, more specifically from an elevated structure, to a lower level, the rescue arrangement comprising:
guiding means which substantially extend between the higher level and the lower level,
carrying means which are connectable with the guiding means for carrying an object, in particular a person, from the higher level to the lower level via the guiding means,
first braking means located at the guiding means near the lower level for slowing down and/or stopping the carrying means near the lower level.

Such a rescue arrangement is known from U.S. Pat. No. 4,593,787 which discloses a system where a guiding means in the form of a secured wired rope is hanging from a an elevated structure. The lower end of the wired rope branches to at least two wired ropes. The branches are secured to reels which are widely separated from each other so that the branches in a tightened state form a pyramid. The reels are provided with braking means to release the branches from the reels in a controlled manner. A person standing on the elevated structure can connect a carrying means like a harness to the wired rope by means of a clasp and jump from the elevated structure. When the clasp reaches the branches it will tension the branches and the branches will be released by the reels in a controlled manner and the person in the harness is slowed down and can land at a safe speed on the ground.

A drawback of the known arrangement is that a person jumping from the elevated structure during his descent along the wired rope can rotate and swing with respect to the rope. These are uncontrolled movements which can for instance cause the person to hit the elevated structure which on its turn can cause injury. Also the uncontrolled movements can cause the descending person to get disorientated, which has a negative effect on the, in an emergency usually necessary, speed of action on arrival at the lower level.

An object of a first aspect of the invention is to provide a rescue arrangement which reduces the uncontrolled movements during the descent.

This object is reached by a rescue arrangement according to the preamble of claim 1, wherein the guiding means comprise at least two substantially parallel tracks, wherein the carrying means are adapted to be connected to at least two of the tracks.

A person descending which is connected to at least two tracks is prevented from rotating and has a reduced freedom for a swinging movement. Thereby the risk of hitting the elevated structure and consequent injury and the disorientation of the descending person are reduced.

As guiding means are preferably used cables, which are secured to the elevated structure and at the lower level with securing means. It is also possible to use solid or hollow rod or bar sections as guiding means instead of cables.

With the known rescue arrangement from U.S. Pat. No. 4,593,787 persons have to disconnect the carrying means from the guiding means themselves when they have arrived at the lower level. The tightened branches of the wired ropes are placed under a considerable tension, which makes it difficult to release the carrying means. Further, people in an emergency situation are usually stressed, which makes them unable to quickly release the carrying means. This limits the amount of people that can be rescued per time unit, since a second person cannot arrive at the lower level before a first person is released and removed from the guiding means, and forms a drawback of the known arrangement.

An object of a second aspect of the invention is to provide an improved rescue arrangement where the amount of people that can be rescued in a certain period of time is increased.

This object is reached by a rescue arrangement according to the preamble of claim 7, wherein the arrangement is adapted for automatically releasing the carrying means from the guiding means at the lower level. In a preferred embodiment the rescue arrangement comprises release means for automatically releasing the carrying means from the guiding means.

By automatically releasing the carrying means from the guiding means the releasing speed is not dependent on the descended person and is thereby increased. As a result of this the amount of people that can be rescued in a certain time is increased.

With the known rescue arrangement from U.S. Pat. No. 4,593,787 if a descended person in a carrying means is released, he has to get out of the way so that a following person can arrive at the lower level. However, people tend to be confused, stressed and disorientated after a guided free fall from a great height. This can negatively influence their ability to move away from the guiding means and can therefore negatively influence the number of people that can descend per time unit.

An object of a third aspect of the invention is to provide an improved rescue arrangement where the amount of people that can be rescued in a certain period of time is increased.

This can be achieved by a rescue arrangement according to the preamble of claim 11, wherein the arrangement comprises means for moving the object, in particular the person, away automatically from the guiding means after the carrying means have been released from the guiding means or the object has been released from the carrying means.

Hereby a descended person is moved out of the way automatically without being dependent on actions of the person. This means that in general the speed of removing the person away from the guiding means is increased, which increases the amount of people that can descend in a certain period of time.

With the known arrangement from U.S. Pat. No. 4,593,787 during braking of a descending person the branches are released from reels in a controlled manner through the use of the braking means provided on the reels. A drawback of this known design is that the branches have to be reeled back on the reels after the descended person is released before another person can descend. This reeling up of the branches is time consuming and will lead to a low capacity in terms of descending/rescued people per time unit.

An object of a fourth aspect of the invention is to provide an improved rescue arrangement where the amount of people that can be rescued in a certain period of time is increased.

This is achieved by a rescue arrangement according to the preamble of claim 12, wherein the first braking means comprise magnetic means for exerting a braking force on the carrying means.

Magnetic breaking means are known from other fields and are proven technology for slowing down objects. Applying magnetic breaking means in the rescue arrangement has the advantage that a breaking means is provided which is continuously working and can brake high numbers of objects in a short period of time. This implies that the capacity of the rescue arrangement is not limited by the breaking means. As an example of a breaking means can be thought of a magnetic brake which induces a magnetic field by a passing magnetic object.

It will be understood that the mentioned four aspects of the invention can be combined.

Further details of the invention will become clear from the following description with reference to the acompanying drawing, wherein:

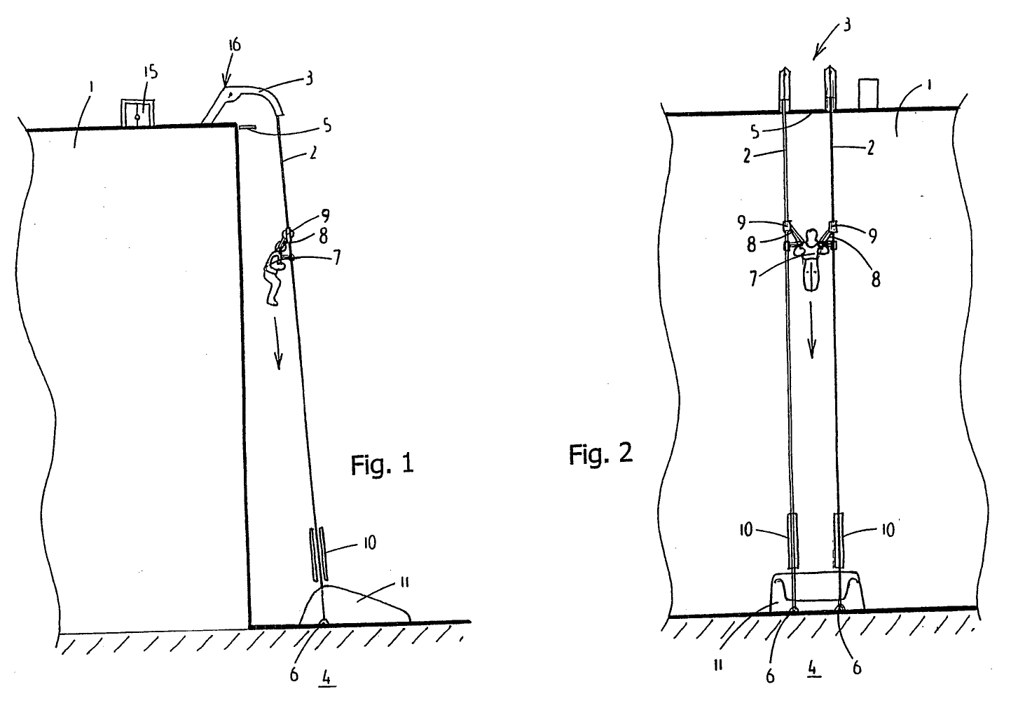

FIG. 1 shows a schematic side view of the arrangement according to the invention,

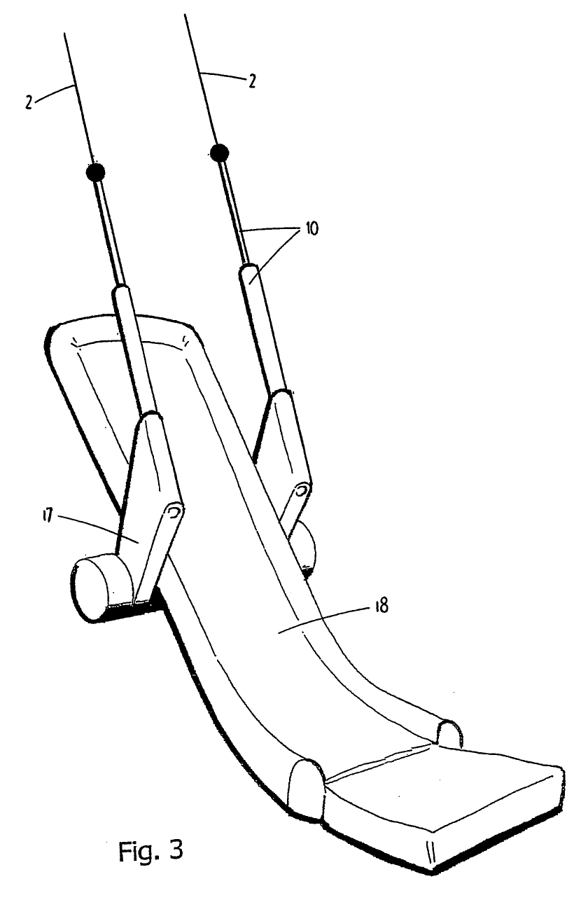

FIG. 2 shows a schematic front view of the arrangement from FIG. 1, and

FIG. 3 shows a detail of a preferred embodiment of the arrangement at the lower level.

In FIGS. 1 and 2 an elevated structure 1 is shown. This can be a sky scraper or another structure. In case of an emergency, cables 2 can be let down to the ground level 4 from an overhanging structure 3. The overhanging structure 3 is placed on and secured to the elevated structure 1, for instance at the roof.

The cables are arranged substantially parallel. At the high level the cables 2 are secured to the overhanging structure 3. At the ground level the cables 2 are secured by securing means 6. This can be for instance reels to which the cables are reeled. In order to tension the cables, the reels can be used as tensioning means. Tensioning of the cables can however also take place by other means.

At the overhanging structure 3 is provided a platform 5. A person standing on the platform 5 has to wear a harness 7 or another carrying means. To make sure that a person on the platform is wearing a harness 7 it is favourable that there is a storage 15 for harnesses 7 near the rescue arrangement, for instance on the roof of the structure. Further, it is possible to provide a preconnecting section 16 where a harness 7 can be connected to the cables so that it is certain that a person who steps on the platform 5 is already coupled to the cables 2.

The harness 7 is provided with straps 8 which have at their free end means 9 that can be coupled to the cables 2 and which can be moved along the cables in a guided way. The means 9 can be provided with rings which can be clipped around the cables 2, but the means 9 can also be provided with wheels which can roll along the cables 2. The means 9 are preferably provided with a magnetic or magnetizable parts (not shown) for a reason which will become clear hereinafter.

The person wearing a harness 7 can attach the means 9 to the cables 2 in the preconnecting section 16, move on to the platform 5 and jump from the platform 5. The means slide or roll along the cables 2 during descent, which results in a guided fall from the elevated structure 1 to the ground level 4. Since the harness 7 is attached to two substantially parallel cables 2, the person and the harness 7 will remain between the cables 2 during descent and the freedom of movement is limited.

Near the ground level 4 there are provided first braking means 10 for slowing down and/or stopping the harness 7. Preferably the first braking means 10 comprise magnetic means for exerting a magnetic force on the magnetic or magnetizable parts of the means 9. The magnetic or magnetizable parts from the means 9 can comprise a metal plate. However, the first braking means 10 do not necessarily have to exert a magneticly induced force, but can also be designed to exert a mechanical or hydraulic force to the carrying means.

It is possible to provide second braking means (not shown) between the higher level and the first braking means. The carrying means and the person in it are then slowed down intermediately, which can be favourable, especially in case of a descent from a great height, because the carrying means near the ground level does not at once have to be decelerated from a very high speed, which causes the person to experience high deceleration forces. Also the second braking means comprise magnetic means for exerting a braking force on the carrying means.

In the figures the first braking means 10 and the securing means 6 are provided on a unit 11 which is placed on the ground level 4. The unit 11 can for instance be provided with release means (not shown) for automatically releasing the means 9 of the harness 7 and the person in it from the cables 2 at the ground level. Also, in the unit 11 means (not shown) for moving a descended person with the harness 7 away from the cables 2 after the means 9 are released from the cables 2 by the release means. The means for moving a descended person away can for example be a conveyor belt type means, which turns constantly and moves the person landing on it directly away.

It is possible to secure the guiding means at the lower level in such a way, that they form a sort of open end, where the means 9 slide off the guiding means automatically. In this way a very simple and effective way to automatically release a carrying means from the guiding means is provided.

In FIG. 3 a detail of a preferred embodiment is shown of the arrangement at the lower level, for instance on a unit 11. FIG. 3 shows the cables 2 which are connected to braking means 10. The braking means 10 are secured by securing means 17, which can also be used to tension the cables 2. Between the cables 2 a chute 18 is placed. The descended people that are released, slide further down along the chute 18 and out of the way of the landing spot.

The unit 11 can be placed near a high strucure permanently as a stand alone unit as is shown in the figures. The unit can also be placed on and secured to a fire truck, which has the advantage that it can be used for more than one building, because it can be transported to a structure where an emergency occurs.

Also the whole rescue arrangement according to the invention can be a mobile arrangement which can for instance on a fire truck be transported to an emergency site. It is also possible that the arrangement is placed at a building in a permanent manner.

1-19. (canceled)

20. A rescue arrangement for effecting a rapid descent from a higher level to a lower level, the rescue arrangement comprising:
guiding means which substantially extend between the higher level and the lower level,
carrying means which are connectable with the guiding means for carrying an object from the higher level to the lower level via the guiding means,
first braking means located at the guiding means near the lower level for slowing down and/or stopping the carrying means near the lower level,
wherein the guiding means comprise at least two substantially parallel tracks, wherein the carrying means are adapted to be connected to at least two of the tracks.

21. Rescue arrangement according to claim 20, wherein the parallel tracks are formed by cables which are secured at the higher level and at the lower level.

22. Rescue arrangement according to claim 20, wherein the parallel tracks are formed by rods or bars which are secured at the higher level and at the lower level.

23. Rescue arrangement according to claim 20, wherein the arrangement further is adapted for automatically releasing the carrying means from the guiding means at the lower level.

24. Rescue arrangement according to claim 23, further comprising release means for automatically releasing the carrying means from the guiding means at the lower level.

25. Rescue arrangement according to claim 20, further comprising means for moving the object away from the guiding means after the carrying means have been released from the guiding means or the object has been released from the carrying means.

26. Rescue arrangement according to claim 20, wherein the first braking means comprise magnetic means for exerting a braking force on the carrying means.

27. A rescue arrangement for effecting a rapid descent from a higher level to a lower level, the rescue arrangement comprising:
guiding means which substantially extend between the higher level and the lower level,
carrying means which are connectable with the guiding means for carrying an object from the higher level to the lower level via the guiding means,
first braking means located at the guiding means near the lower level for slowing down and/or stopping the carrying means near the lower level, wherein the arrangement is adapted for automatically releasing the carrying means from the guiding means at the lower level.

28. Rescue arrangement according to claim 27, further comprising release means for automatically releasing the carrying means from the guiding means at the lower level.

29. Rescue arrangement according to claim 27, further comprising means for moving the object away automatically from the guiding means after the carrying means have been released from the guiding means or the object has been released from the carrying means.

30. Rescue arrangement according to claim 27, wherein the first braking means comprise magnetic means for exerting a braking force on the carrying means.

31. Rescue arrangement for effecting a rapid descent from a higher level, to a lower level, the rescue arrangement comprising:
guiding means which substantially extend between the higher level and the lower level,
carrying means which are connectable with the guiding means for carrying an object from the higher level to the lower level via the guiding means,
first braking means located at the guiding means near the lower level for slowing down and/or stopping the carrying means near the lower level,
wherein the arrangement comprises means for moving the object away automatically from the guiding means after the carrying means have been released from the guiding means or the object is released from the carrying means.

32. Rescue arrangement for effecting a rapid descent from a higher level to a lower level, the rescue arrangement comprising:
guiding means which substantially extend between the higher level and the lower level,
carrying means which are connectable with the guiding means for carrying an object from the higher level to the lower level via the guiding means,
first braking means located at the guiding means near the lower level for slowing down and/or stopping the carrying means near the lower level,
wherein the first braking means comprise magnetic means for exerting a braking force on the carrying means.

33. Rescue arrangement according to 32, wherein second braking means are provided between the higher level and the first braking means.

34. Rescue arrangement according to claim 33, wherein the second braking means comprise magnetic means for exerting a braking force on the carrying means.

35. Rescue arrangement according to claim 20, wherein the guiding means at the lower level are secured to a fire truck.

36. Rescue arrangement according to claim 20, wherein the first braking means are provided on a fire truck.

37. Rescue arrangement according to claim 21, wherein the arrangement comprises tensioning means for tensioning the cables.

38. Rescue arrangement according to claim 37, wherein the tensioning means are provided on a fire truck.

39. Rescue arrangement according to claim 20, wherein the carrying means comprise a harness which is adapted to carry a person.
